(19) United States
(12) Patent Application Publication
(10) Pub. No.: US 2026/0065296 A1
(43) Pub. Date: Mar. 5, 2026

(54) SYSTEM AND METHOD FOR TRACKING AND VERIFYING GREENHOUSE GAS (GHG) DECARBONIZATION THROUGH USER-DRIVEN VERIFICATION

(71) Applicant: Oksana Butramiieva, Kyiv (UA)

(72) Inventor: Oksana Butramiieva, Kyiv (UA)

(21) Appl. No.: 19/309,218

(22) Filed: Aug. 25, 2025

Related U.S. Application Data
(60) Provisional application No. 63/690,842, filed on Sep. 5, 2024.

(51) Int. Cl. G06Q 30/018

(52) U.S. Cl. CPC G06Q 30/018

(57) ABSTRACT

Disclosed are a system and method for tracking and verifying greenhouse gas (GHG) emissions and decarbonization activities of users. The method includes collecting consumption data from various sources and calculating decarbonization values based on time-based comparisons between eco-verification datasets. The method generates machine-readable codes embedding verified GHG emission data and digitally signed environmental certifications. Real-time activity and mobility data are obtained from wearable devices through health APIs to enhance emissions accuracy. Users are enabled to evaluate the ecological practices of commercial properties using predefined sustainability criteria. Secure user and reviewer identification is supported. A GHG meter aggregates data using predefined conversion metrics and integrates it with household sensor feeds and smart devices. A digital interface displays verified consumption data, eco-badges, historical decarbonization trends, and GHG reduction timelines, providing users with a transparent and comprehensive overview of their environmental impact and encouraging data-driven behavioral change for decarbonization.

### TECHNOLOGICAL FIELD

The present disclosure generally relates to systems and methods for accurately calculating and verifying greenhouse gas (GHG) emissions produced by individuals and more particularly relates to systems and methods for tracking and verifying GHG decarbonization through user-driven verification.

### BACKGROUND

The greenhouse effect is a crucial natural process that maintains the earth's temperature by trapping heat in the atmosphere. However, human activities, such as individual consumption patterns and lifestyle choices, have dramatically increased greenhouse gas concentrations, contributing to global warming and its harmful environmental impacts. As individuals play a significant role in these emissions, there is an increasing need for effective methods to monitor and reduce personal greenhouse gas emissions.

Current methods for calculating an individual's greenhouse gas emissions often face challenges in accuracy and practicality. Many traditional approaches rely on self-reporting by individuals, which can be susceptible to errors or intentional misreporting. Additionally, these methods often fail to account for the comprehensive scope of an individual's daily activities, resulting in an incomplete assessment of their personal environmental impact. This lack of precision limits the effectiveness of existing emission monitoring solutions.

The current state of the art in personal greenhouse gas emissions monitoring is characterized by several disadvantages. Firstly, existing methods often depend on self-reported data or incomplete information, leading to inaccuracies in the results. Secondly, these methods typically do not capture the full range of an individual's activities, providing a limited perspective on their overall environmental impact. Thirdly, the processes involved can be time-consuming and costly, discouraging individuals from actively monitoring and reducing their emissions.

This specification recognizes that there is a need for a system to address the shortcomings of existing methods by delivering precise, real-time monitoring of personal emissions.

Further limitations and disadvantages of conventional approaches will become apparent to one of skill in the art through the comparison of described systems with some aspects of the present disclosure, as outlined in the remainder of the present application and with reference to the drawings.

### BRIEF SUMMARY OF SOME EXAMPLE EMBODIMENTS

In order to solve the foregoing problem, the present disclosure may provide systems and methods for tracking and verifying greenhouse gas (GHG) emissions and decarbonization.

In one aspect, a system for tracking and verifying greenhouse gas (GHG) emissions and decarbonization is provided. The system includes a memory and a computer processor. The memory is configured for storing program instructions and the computer processor is coupled to the memory and executing the program instructions. The memory includes a data acquisition module, a decarbonization quantification module, a digital certification module, a wearable integration module, an eco-rating module, and an access control and authentication module. The data acquisition module is configured to collect consumption data from a set of sources comprising at least one of the service provider APIs, data aggregators, manual user input, and user-permitted access to third-party data. The decarbonization quantification module is configured to compute a decarbonization value of one or more users based on a temporal comparison between at least two eco-verification datasets and is further configured to support analysis for both personal and commercial entities. The digital certification module is configured to generate a set of machine-readable codes (QR codes) to embed either verified GHG emission data or a set of digitally signed environmental certifications. The wearable integration module is configured to collect one or more of real-time activity data, and mobility data from a set of wearable devices via a set of health APIs, wherein such data is processed as a proxy for GHG emissions. The eco-rating module includes a map-based interface configured to allow one or more users to rate ecological practices of commercial properties based on predefined criteria, wherein such inputs are used to calculate a weighted ecological score for each business and track changes in ratings over time. The access control and authentication module is configured to support secure identification of the one or more users and a set of reviewers via a set of know-your-customer (KYC) protocols and role-based access control to data and system functionalities. The GHG meter is configured to aggregate collected data and compute GHG emissions using a set of predefined conversion metrics. The GHG meter is integrated with a set of household sensor feeds and capable of receiving data from a set of smart devices including but not limited to water, electricity, and gas meters, and vehicle OBD2 interfaces. The digital interface or a user cabinet is configured to display verified consumption data, one or more eco-badges, a set of GHG trends, and a set of historical decarbonization timelines for a user or business.

In additional system embodiments, the data acquisition module includes a permission layer to enable a user-specific control over each external data source.

In additional system embodiments, the GHG meter includes a real-time dashboard configured to display emissions levels and trigger alerts upon exceeding predefined consumption thresholds.

In additional system embodiments, the decarbonization quantification module is configured to apply regression analysis to identify trends in emission reductions across time intervals.

In additional system embodiments, the wearable integration module supports battery-efficient data polling and includes a user consent mechanism compliant with data privacy regulations.

In additional system embodiments, the eco-rating module is configured to calculate ecological scores based on weighted inputs selected from a dropdown menu, such as packaging materials, energy sources, and supply chain transparency.

In additional system embodiments, the digital interface is configured to issue the one or more eco-badges comprising “EcoVerified” and “EcoVerified After Compensation” based on cumulative emissions data.

In additional system embodiments, the access control module is configured to define at least four user roles comprising an individual user, a reviewer, a third-party verifier, and a public viewer, each with distinct permission levels.

In additional system embodiments, the system further includes an off-chain data storage interface for storing historical GHG data, eco-reviews, and certification records in a secure, timestamped manner.

In additional system embodiments, the decarbonization quantification module is configured to incorporate review-based inputs from the eco-rating module into a decarbonization estimation formula, the formula applying time-weighted adjustments to reflect ecological improvements based on user-submitted ratings of business practices.

In additional system embodiments, the compensation actions logged in the compensation logging module affect the issuance or upgrade of eco-badges displayed in the user cabinet.

In additional system embodiments, the review-based decarbonization estimation formula assigns weighted scores to user ratings based on criteria selected from a predefined list and computes an updated ecological score over time to reflect changes in commercial property behavior.

In yet another aspect, a method for tracking and verifying greenhouse gas (GHG) emissions and decarbonization is provided. The method includes a step of collecting, by a computer, consumption data from a set of sources. The method includes a step of computing, by the computer, a decarbonization value of one or more users based on a temporal comparison between at least two eco-verification datasets. The method includes a step of generating, by the computer, a set of machine-readable codes to embed either verified GHG emission data and/or a set of digitally signed environmental certifications. The method includes a step of collecting, by the computer, one or more of real-time activity data, and mobility data from a set of wearable devices via a set of APIs. The method includes a step of allowing, by the computer, the one or more users to rate ecological practices and services of commercial properties based on predefined criteria. The method includes a step of supporting, by the computer, secure identification of the one or more users and a set of reviewers. The method includes a step of aggregating, by a GHG meter, collected data and computing GHG emissions using a set of predefined conversion metrics. The GHG meter is integrated with a set of household sensor feeds and is capable of receiving data from a set of smart devices. The method includes a step of displaying, by a digital interface, one or more of verified consumption data, one or more eco-badges, a set of GHG trends, and a set of historical decarbonization timelines. The method further includes a step of applying, by the computer, regression analysis to identify trends in emission reductions across time intervals. The method further includes a step of calculating, by the computer, ecological scores based on weighted inputs selected from a dropdown menu.

In additional method embodiments, the GHG meter includes a real-time dashboard configured to display emissions levels and trigger alerts upon exceeding predefined consumption thresholds.

In additional method embodiments, the digital interface is configured to issue the one or more eco-badges comprising “EcoVerified” and “EcoVerified After Compensation” based on cumulative emissions data.

In additional method embodiments, the digital interface is configured to assign the one or more eco-badges based on GHG emission thresholds.

In additional method embodiments, the set of sources includes but is not limited to a set of service provider APIs, a set of data aggregators, a manual user input, and user-permitted access to third-party data.

Accordingly, one advantage of the present invention is that it ensures accurate data collection and processing while minimizing the time and resources required for emission calculations. By providing a comprehensive view of an individual's consumption patterns, the present invention empowers individuals to make informed decisions about their environmental impact and contribute actively to global efforts to combat climate change.

Accordingly, one advantage of the present invention is that it creates a robust personal greenhouse gas emissions verification system that leverages advanced technology to accurately measure, verify, and evaluate an individual's greenhouse gas emissions based on their personal consumption, with their consent.

Accordingly, one advantage of the present invention is that it provides extensive coverage by incorporating detailed information about an individual's consumption habits, facilitating thorough monitoring of their emissions and promoting accountability and sustainability at the individual level.

Accordingly, one advantage of the present invention is that it emphasizes on the role of individuals in greenhouse gas emissions and provides personalized solutions for monitoring and reducing their environmental impact.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of a system for tracking and verifying greenhouse gas (GHG) emissions and decarbonization, in accordance with one or more example embodiments.

FIG. 2 illustrates an exemplary block diagram of the system, in accordance with one or more example embodiments.

FIG. 3 illustrates a data flow process and operations of the present system, in accordance with at least one embodiment.

FIG. 4 illustrates a flowchart of a method for tracking and verifying greenhouse gas (GHG) emissions and decarbonization, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

As used herein, “greenhouse gas” (GHG) refers to any gaseous compound in the Earth's atmosphere that is capable of absorbing infrared radiation to trap and hold heat. Greenhouse gases contribute to the greenhouse effect and global warming. Common examples include but are not limited to, carbon dioxide (CO₂), methane (CH₄), nitrous oxide (N₂O), ozone (O₃), and fluorinated gases such as hydrofluorocarbons (HFCs), perfluorocarbons (PFCs), sulfur hexafluoride (SF₆), and nitrogen trifluoride (NF₃).

The embodiments are described herein for illustrative purposes and are subject to many variations. It is understood that various omissions and substitutions of equivalents are contemplated as circumstances may suggest or render expedient but are intended to cover the application or implementation without departing from the scope of the present disclosure. Further, it is to be understood that the phraseology and terminology employed herein are for the description and should not be regarded as limiting. Any heading utilized within this description is for convenience only and has no legal or limiting effect.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,“and the like or the respective closed phrases ”consisting of,“”consists of, the like.

As used herein, the singular forms “a,” “an,” and “the” designate both the singular and the plural, unless expressly stated to designate the singular only.

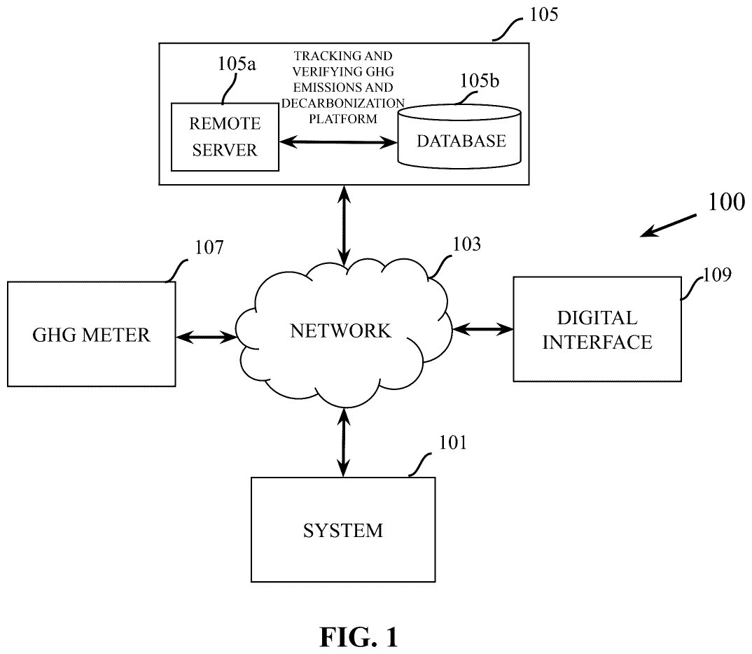

FIG. 1 illustrates a block diagram 100 showing an example architecture of a system 101 for tracking and verifying greenhouse gas (GHG) emissions and decarbonization, in accordance with one or more example embodiments. As illustrated in FIG. 1, block diagram 100 may comprise system 101, a network 103, a tracking and verifying GHG emissions and decarbonization platform 105, a GHG meter 107, and a digital interface 109. The tracking and verifying GHG emissions and decarbonization platform 105 includes a remote server 105a, and a database 105b. The components described in the block diagram 100 may be further broken down into more than one component such as one or more modules or applications and/or combined in any suitable arrangement. Further, it is possible that one or more components may be rearranged, changed, added, and/or removed without deviating from the scope of the present disclosure.

In various embodiments, the remote server 105a may receive the data from various data sources such as service provider APIs, data aggregators, manual user input, and user-permitted access to third-party data, and social media, over the network 103. For example, system 101 may be embodied as a cloud-based service, a cloud-based application, a cloud-based platform, a remote server-based service, a remote server-based application, a remote server-based platform, or a virtual computing system. In each of such embodiments, system 101 (computer-implemented system) may be communicatively coupled to the components shown in FIG. 1 to carry out the desired operations and wherever required modifications may be possible within the scope of the present disclosure.

In various embodiments, system 101, database 105b, and remote server 105a are connected over the network 103 for data transmission. The network 103 may be wired, wireless, or any combination of wired and wireless communication networks, such as cellular, Wi-Fi, internet, local area networks, or the like. In some embodiments, network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The database 105b may include data received from the online channels, offline channels, social media, and CRM systems. The database 105b may be communicatively coupled to the remote server 105a. The remote server 105a may comprise one or more processors configured to process requests received from the computer-implemented system 101 or may be referred to as an environmental monitoring system. The processor may fetch data from database 105b and transmit the same to system 101 in a format suitable for use by computer-implemented system 101.

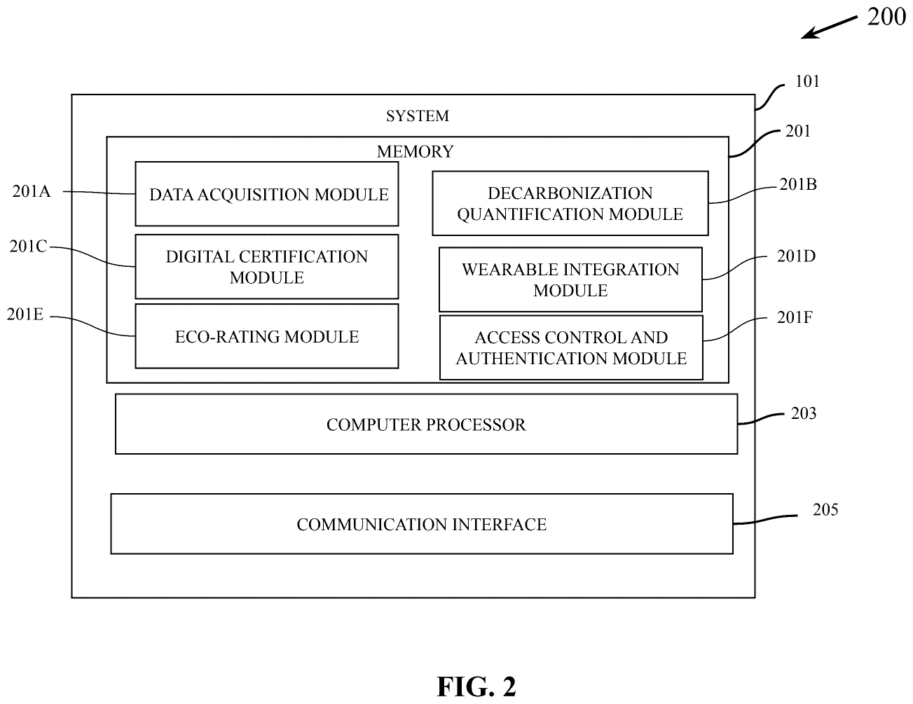

FIG. 2 illustrates an exemplary block diagram 200 of the present system 101 for tracking and verifying greenhouse gas (GHG) emissions and decarbonization, in accordance with one or more example embodiments. FIG. 2 is explained in conjunction with elements of FIG. 1. The system 101 includes a memory 201, a computer processor 203, and a communication interface 205. Memory 201 is configured for storing program instructions. In an embodiment, the memory 201 is further configured for storing a data acquisition module 201A, a decarbonization quantification module 201B, a digital certification module 201C, a wearable integration module 201D, an eco-rating module 201E, and an access control and authentication module 201F. The computer processor 203 is coupled to the memory 201 and executes the program instructions for executing a method for tracking GHG emissions data, wherein the GHG emissions data may be obtained from the remote server 105a. The GHG emissions data and decarbonization data are stored in a database 105b associated with the tracking and verifying GHG emissions and decarbonization platform 105. In an embodiment, the data acquisition module 201A is configured to collect consumption data from a set of sources comprising at least one of the service provider APIs, data aggregators, manual user input, and user-permitted access to third-party data. In an embodiment, the data acquisition module 201A includes a permission layer to enable a user-specific control over each external data source.

The decarbonization quantification module 201B is configured to compute a decarbonization value of one or more users based on a temporal comparison between at least two eco-verification datasets and is further configured to support analysis for both personal and commercial entities. In an embodiment, the decarbonization quantification module 201B is configured to apply regression analysis to identify trends in emission reductions across time intervals. Typically, the decarbonization method is based on personal ecoverification and/or review of personal ecomaps to reduce greenhouse gas (GHG) emissions by individuals, and households. This method calculates a historical regression in the user's GHG emissions, as determined through ecoverification, which involves the validation and analysis of consumption data. The decarbonized amount is defined as the difference between two GHG emission values obtained from the user's two most recent ecoverification results. Specifically, the method subtracts the most recent GHG emission value (obtained from the latest ecoverification) from the preceding GHG emission value (from the prior ecoverification). This difference represents the quantified amount of GHG emissions that the user has successfully reduced. A minimum of two completed eco-verifications is required to perform this calculation and determine a measurable reduction. The method allows individuals to actively participate in and contribute to decarbonization by enabling the precise measurement of personal GHG emission reductions. The calculated decarbonized amount can be visually displayed via a user interface on smart devices, including but not limited to GHG meters for households, smartwatches, smartphones, tablets, computers, and laptops.

The digital certification module 201C is configured to generate a set of machine-readable codes (QR codes) to embed either verified GHG emission data or a set of digitally signed environmental certifications. In an embodiment, the QR code includes a digitally signed payload corresponding to a particular eco-verification event timestamp. These QR codes act as verifiable proof of a user's environmental performance and sustainability metrics. The QR codes may be generated following successful ecoverification and contain encoded data representing authenticated GHG emission values, reductions, timestamps, user identification, and optional cryptographic digital signatures to ensure data integrity and prevent tampering. These QR codes can be displayed or embedded in personal resumes, online social profiles, business websites, or other digital platforms as a means of publicly demonstrating verified environmental responsibility and performance.

The wearable integration module 201D is configured to collect one or more of real-time activity data, and mobility data from a set of wearable devices via a set of health APIs, wherein such data is processed as a proxy for GHG emissions. In an embodiment, the wearable integration module 201D supports battery-efficient data polling and includes a user consent mechanism compliant with data privacy regulations. In some embodiments, a direct connection to smartwatches and fitness trackers for collecting real-time mobility and activity data is utilized as a proxy for estimating GHG emissions. The present system may interface with wearable devices to monitor user movement patterns, such as walking, cycling, or vehicle transport, and correlate these activities with corresponding emission factors. The data collection process includes battery-efficient polling techniques to minimize energy consumption on the wearable device. User consent is obtained through an explicit opt-in mechanism, ensuring compliance with privacy standards and data protection regulations. Integration is achieved via standardized health and fitness application programming interfaces (APIs), such as Apple HealthKit, Google Fit, or manufacturer-specific APIs, allowing seamless synchronization of relevant activity data into the decarbonization analysis framework.

The eco-rating module 201E includes a map-based interface configured to allow one or more users to rate ecological practices of commercial properties based on predefined criteria, wherein such inputs are used to calculate a weighted ecological score for each business and track changes in ratings over time. In an embodiment, the eco-rating module 201E is configured to calculate ecological scores based on weighted inputs selected from a dropdown menu, including but not limiting to the following: packaging materials, energy sources, supply chain transparency, excessive energy consumption from heating, ventilation, air conditioning, lighting systems, continuous operation of electronic equipment and appliances including multimedia displays and kitchen devices, inefficient food preparation and storage practices leading to elevated energy usage and spoilage, generation of food and packaging waste including non-recyclable and single-use materials, disposal of organic waste without composting or separation from general waste streams, high water consumption and energy loss through heating and inefficient plumbing fixtures, transportation-related emissions from customer, employee, and supplier vehicle use, poor waste segregation and limited recycling or composting infrastructure, use of environmentally intensive cleaning products and disposable cleaning materials, frequent laundering and textile waste associated with uniforms and linens, emissions from maintenance, refurbishment, and construction activities, energy inefficiency due to outdated or poorly insulated infrastructure.

In an embodiment, the decarbonization quantification module 201B is configured to incorporate review-based inputs from the eco-rating module 201E into a decarbonization estimation formula. The formula applies time-weighted adjustments to reflect ecological improvements based on user-submitted ratings of business practices. In an embodiment, the review-based decarbonization estimation formula assigns weighted scores to user ratings based on criteria selected from a predefined list and computes an updated ecological score over time to reflect changes in commercial property behavior. In an embodiment, the compensation actions logged in the compensation logging module affect the issuance or upgrade of eco-badges displayed in the user cabinet.

The access control and authentication module 201F is configured to support secure identification of the one or more users and a set of reviewers via a set of know-your-customer (KYC) protocols and role-based access control to data and system functionalities. In an embodiment, the access control and authentication module 201F is configured to define at least four user roles, each with distinct permission levels and system privileges. The user roles include: 1. An individual user who submits data or content into the system and has access to view, edit, and track their own submissions and associated records. 2. Reviewer who is responsible for evaluating submissions made by individual users. Reviewers may have access to view, comment on, or approve/reject content, but cannot modify original submissions. 3. Third-party Verifier: An external auditor or verifying authority granted limited access to validate specific data points or credentials provided by the individual user or reviewer, typically without access to broader system functionality. 4. Public Viewer: A general-access user who can view only publicly disclosed or anonymized data, without any ability to interact with, modify, or trace user-submitted records.

The GHG meter 107 (shown in FIG. 1) is configured to aggregate collected data and compute GHG emissions using a set of predefined conversion metrics. The GHG meter 107 is integrated with a set of household sensor feeds and capable of receiving data from a set of smart devices including but not limited to water, electricity, and gas meters, and vehicle OBD2 interfaces. In an embodiment, the GHG meter 107 includes a real-time dashboard configured to display emissions levels and trigger alerts upon exceeding predefined consumption thresholds. In some embodiments, the GHG meter 107 is configured to integrate data from multiple smart home devices and Internet of Things (IoT) sensors to calculate and monitor household GHG emissions. The GHG meter 107 aggregates data from sources such as smart thermostats, energy meters, water usage monitors, and appliance-level sensors to provide a comprehensive emissions profile. The system includes real-time dashboards for visualizing current and historical GHG emissions, along with user-specific trends. Additionally, the GHG meter is equipped with an alert mechanism that notifies users when consumption exceeds predefined thresholds, thereby enabling timely behavioral adjustments to reduce environmental impact.

In an operation of the GHG meter 107, upon obtaining user consent, the system establishes secure connections to various service APIs to retrieve consumption data. This includes data from utility providers such as gas meters, electrical meters, and water meters, as well as personal consumption data associated with individuals residing in the household. In addition to API-based data collection, a dedicated GHG Meter may be employed to capture real-time consumption data directly from smart household devices and meters to enhance the accuracy and granularity of environmental impact assessments. All collected data is stored within the user's cabinet, a secure, individualized account that serves as a repository for environmental data and related analytics. The system processes the consumption data using established Environmental, Social, and Governance (ESG) reporting methodologies, including Scope 1 (direct emissions), Scope 2 (indirect emissions from purchased energy), and Scope 3 (other indirect emissions, such as individual consumption patterns). In some embodiments, the APIs are configured to store transactions to show energy-related consumption data.

To assess environmental progress, the system performs a comparative analysis of the current and previous ecoverification results. The calculated difference represents the user's decarbonization amount, a quantified reduction in greenhouse gas emissions over time. Based on this result, the system generates and issues an Ecoverification Badge, which reflects the user's current emissions status and serves as a behavioral tool to encourage continued sustainable consumption practices.

The digital interface 109 (shown in FIG. 1) or a user cabinet is configured to display verified consumption data, one or more eco-badges, a set of GHG trends, and a set of historical decarbonization timelines for a user or business. In an embodiment, the digital interface 109 is configured to issue the one or more eco-badges comprising “EcoVerified” and “EcoVerified After Compensation” based on cumulative emissions data. In an embodiment, the digital interface 109 (referred to as a user cabinet) is configured to assign one or more eco-badges based on GHG emission thresholds, including at least one badge corresponding to a total emission level below 3 metric tons of CO2 equivalent. In an embodiment, the user cabinet further includes a compensation logging module configured to record offset actions taken by the user, including carbon credits purchased, tree-planting activities, or renewable energy investments, and associate such actions with the user's eco-verification status. In some embodiments, system 101 further includes an off-chain data storage interface for storing historical GHG data, eco-reviews, and certification records in a secure, timestamped manner.

According to some embodiments, each of the components and modules 201A-201F may be embodied in memory 201. The computer processor 203 may retrieve computer program code instructions that may be stored in memory 201 for the execution of computer program code instructions, which may be configured to facilitate data-driven decisions and achieve optimal marketing outcomes.

The computer processor 203 may be embodied in a number of different ways. For example, the computer processor 203 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the computer processor 203 may include one or more processing cores configured to perform independently. A multi-core processor may enable multiprocessing within a single physical package. Additionally, or alternatively, the computer processor 203 may include one or more processors configured in tandem via the bus to enable independent execution of instructions, pipelining, and/or multithreading.

Additionally, or alternatively, the computer processor 203 may include one or more processors capable of processing large volumes of workloads and operations to provide support for big data analysis. In an example embodiment, the computer processor 203 may be in communication with the memory 201 via a bus for passing information to system 101. Memory 201 may be non-transitory and may include, for example, one or more volatile and/or non-volatile memories. In other words, for example, the memory 201 may be an electronic storage device (for example, a computer-readable storage medium) comprising gates configured to store data (for example, bits) that may be retrievable by a machine (for example, a computing device like the computer processor 203). The memory 201 may be configured to store information, data, content, applications, instructions, or the like, to enable the computer processor 203 to carry out various functions in accordance with an example embodiment of the present disclosure. For example, memory 201 may be configured to buffer input data for processing by the computer processor 203. As exemplified in FIG. 2, the memory 201 may be configured to store instructions for execution by the computer processor 203. As such, whether configured by hardware or software methods, or by a combination thereof, the computer processor 203 may represent an entity (for example, physically embodied in circuitry) capable of performing operations according to an embodiment of the present disclosure while configured accordingly. Thus, for example, when the computer processor 203 is embodied as an ASIC, FPGA, or the like, the computer processor 203 may be specifically configured hardware for conducting the operations described herein. Alternatively, as another example, when the computer processor 203 is embodied as an executor of software instructions, the instructions may specifically configure the computer processor 203 to perform the algorithms and/or operations described herein when the instructions are executed. However, in some cases, the computer processor 203 may be a processor-specific device (for example, a mobile terminal or a fixed computing device) configured to employ an embodiment of the present disclosure by further configuration of the computer processor 203 by instructions for performing the algorithms and/or operations described herein. The computer processor 203 may include, among other things, a clock, an arithmetic logic unit (ALU), and logic gates configured to support the operation of the computer processor 203.

The system 101 may be accessed using the communication interface 205 or a user interface. The communication interface 205 may provide an interface for accessing various features and data stored in the system 101. For example, the communication interface 205 may comprise an I/O interface which may be in the form of a GUI, a touch interface, a voice-enabled interface, a keypad, and the like. In an embodiment, the communication interface 205 may present visual reports or dashboards based on insights and forecasts. Users can create and customize dashboards with various widgets and visualizations, which are updated in real-time with the latest data. Interactive visualizations such as charts, graphs, and tables display insights and forecasts. Additionally, the system offers export options to various formats like PDF, Excel, and PowerPoint. Dashboards can be shared with team members, with features for annotations and comments to facilitate sharing and collaboration.

In some embodiments, the present system may facilitate user-submitted reviews of businesses'environmental performance through a map-based digital interface, referred to as the “EcoMap.” The EcoMap enables users to locate businesses and submit structured ecological assessments based on their recent experiences as customers or visitors. Each user is required to log in through a personal account (referred to as the “user cabinet”) and undergo an identification check before submitting a review. Reviews are submitted via a dropdown menu containing predefined environmental criteria, such as the use of compostable or biodegradable packaging, the presence of hand dryers versus paper towels in restrooms, the transparency and sustainability of supply chains or ingredient sourcing, and the implementation of renewable energy sources or recycling programs. Each criterion in the dropdown menu is linked to a weighting algorithm or impact formula, which quantifies the environmental significance of that factor. Upon submission, the user's selections are converted into a numerical ecological score for the business. The system requires a minimum of two separate reviews of the same business by the same user, spaced by a time interval sufficient to allow the business to make potential improvements. After the second review is submitted, the system calculates the difference between the two most recent ecological scores. This difference is defined as the “decarbonized amount,” representing the impact of the user's feedback on the ecological improvement of the business. The decarbonized amount thus provides a quantifiable measure of environmental progress directly influenced by individual participation.

All reviews and associated metrics are stored in the user cabinet to allow the user to track their contributions to business decarbonization over time. The EcoMap platform also supports business participation, enabling entities to maintain accounts where they may submit sustainability reports, undergo ecoverification processes, and receive feedback from users. This system promotes transparency, accountability, and measurable progress toward sustainability goals by leveraging community-based ecological reviews.

In one of the operations, the system initiates a Know Your Customer (KYC) process to authenticate the identity of the individual user. Once verified and upon receiving explicit user consent, the system connects to various third-party service APIs such as utility providers, transportation platforms, and retail services to retrieve personal consumption data. This data is securely stored within the user's Personal Cabinet, a private digital account associated with the user.

Using standardized Environmental, Social, and Governance (ESG) reporting methodologies, the system processes the collected data to calculate the user's greenhouse gas (GHG) emissions across Scope 1 (direct emissions), Scope 2 (indirect emissions from purchased energy), and Scope 3 (other indirect emissions, such as supply chain and consumption-based activities). The system performs a comparative analysis between the current and previous ecoverification results to determine the decarbonization amount. Following the analysis, the user is issued an Ecoverification badge, which reflects their current emissions status. This badge serves not only as a visual indicator of environmental performance but also as a behavioral incentive to promote ongoing sustainable consumption practices.

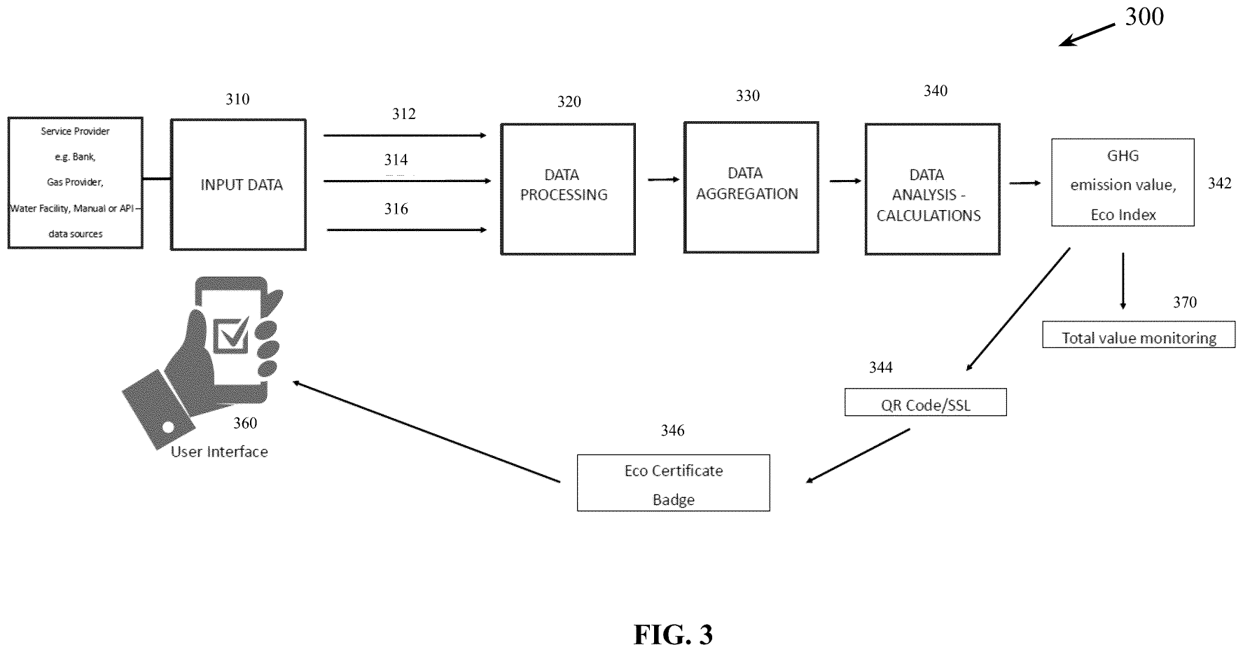

FIG. 3 illustrates a block diagram 300 of a data flow process and operations of the present system, in accordance with at least one embodiment. FIG. 3 is explained in conjunction with FIGS. 1-2. In operation, at block 310, system 100 is configured to receive input data from multiple sources. Input data includes, but is not limited to, supply data 312, API aggregator data 314, and input consumption data 316. Supply data 312 from service providers may be received directly from utility services, such as financial institutions, gas suppliers, and water utilities. This data may include, for example, bank transaction records, utility meter readings, and transit data from railway and bus systems. Such data may be received upon authorization by the user. In certain embodiments, the system may also utilize API aggregator data 314 to collect, normalize, and standardize input from a variety of service providers, thereby ensuring data consistency and accuracy. Examples of such data aggregators include, without limitation, UtilityAPI and Plaid. Additionally, users may manually input consumption data 316 via a user interface platform 360. The user interface platform 360 may comprise, for example, a mobile application or a web-based application. In some embodiments, data may be collected from sensors, such as smartwatches or other wearable devices.

In an exemplary embodiment, system 100 may include a set of adapters 320 that preprocess and standardize incoming data. This preprocessing may include operations such as data cleaning, de-duplication, and the handling of incomplete or missing information. Following preprocessing, the data may be passed to a category detector 130 that classifies the data into predefined categories.

Once categorized, the data may be analyzed by a greenhouse gas (GHG) emissions calculator 340, which processes the categorized data to compute a greenhouse gas emissions score 342 associated with the individual's activities. The GHG emissions score 342 (also referred to as the “EcoIndex”) reflects an estimate of the annual volume of greenhouse gas emissions attributable to the user.

In some embodiments, if the calculated EcoIndex 342 falls below a predetermined threshold, such as 3 tons of CO₂-equivalent emissions per year, the system 100 may generate a QR code 344 or SSL containing a digital certificate signed by a software-as-a-service (SaaS) provider. This certificate may be used for personal identity verification and recognition of environmentally responsible behavior.

Further, system 100 may generate and issue an eco-verification badge 346 or an eco-certificate badge to users whose emissions fall below the defined threshold. The badge may serve as a digital symbol of verified low-emission behavior and may be displayed on digital platforms such as social media profiles and electronic résumés. In instances where a user's emissions exceed the threshold, the system may enable the user to take remedial actions and submit supporting documentation for verification. Upon validation of such remedial efforts (e.g., carbon offsets), the user may still be awarded the eco-certificate badge 346, thereby encouraging ongoing environmental responsibility.

In another embodiment, the system provides functionality for third-party integration of the EcoIndex score 342. External systems may access the emissions score via application programming interfaces (APIs) and incorporate it into broader environmental monitoring platforms or other sustainability evaluation systems.

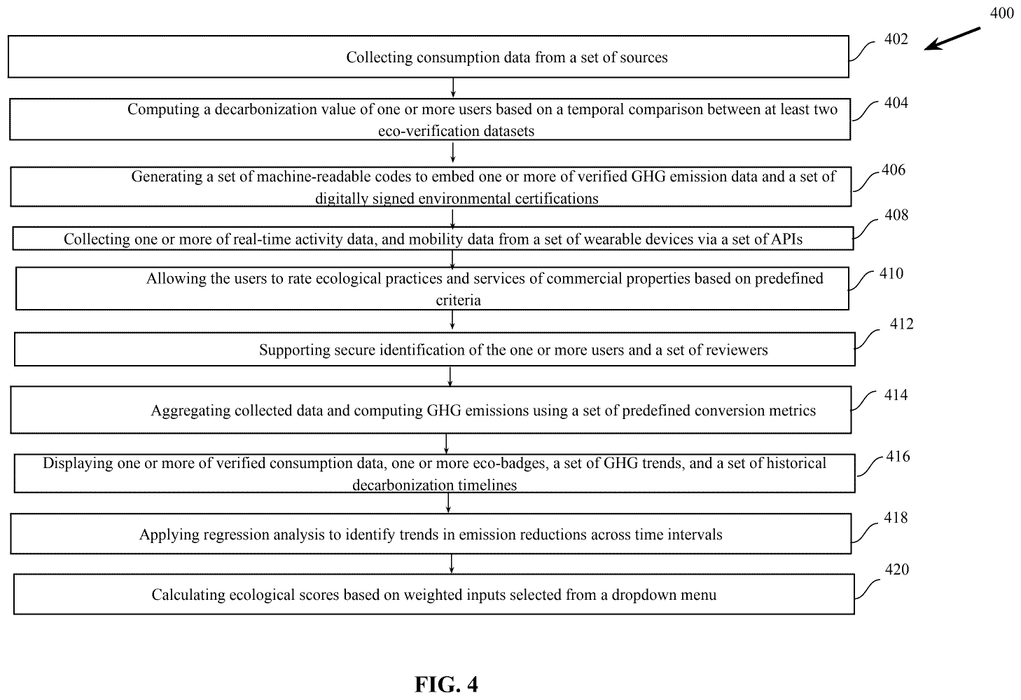

FIG. 4 illustrates a flowchart of method 400 for tracking and verifying greenhouse gas (GHG) emissions and decarbonization, in accordance with one or more example embodiments. FIG. 4 is explained in conjunction with FIGS. 1-3. Method 400 includes a step 402 of collecting, by a computer, consumption data from a set of sources. In an embodiment, the set of sources includes but is not limited to a set of service provider APIs, a set of data aggregators, a manual user input, and user-permitted access to third-party data. Method 400 includes step 404 of computing, by the computer, a decarbonization value of one or more users based on a temporal comparison between at least two eco-verification datasets. The method 400 includes a step 406 of generating, by the computer, a set of machine-readable codes to embed either verified GHG emission data and/or a set of digitally signed environmental certifications. Method 400 includes step 408 of collecting, by the computer, one or more of real-time activity data, and mobility data from a set of wearable devices via a set of health APIs. Method 400 includes a step 410 of allowing, by the computer, the one or more users to rate ecological practices of commercial properties based on predefined criteria. The method 400 includes a step 412 of supporting, by the computer, secure identification of the one or more users and a set of reviewers. Method 400 includes step 414 of aggregating, by a GHG meter, collected data and computing GHG emissions using a set of predefined conversion metrics. The GHG meter is integrated with a set of household sensor feeds and is capable of receiving data from a set of smart devices. In an embodiment, the GHG meter includes a real-time dashboard configured to display emissions levels and trigger alerts upon exceeding predefined consumption thresholds. Method 400 includes a step 416 of displaying, by a digital interface, one or more of verified consumption data, one or more eco-badges, a set of GHG trends, and a set of historical decarbonization timelines. In an embodiment, the digital interface is configured to issue the one or more eco-badges including but not limited to “EcoVerified” and “EcoVerified After Compensation” based on cumulative emissions data. In an embodiment, the digital interface is configured to assign the one or more eco-badges based on GHG emission thresholds. Method 400 further includes a step 418 of applying, by the computer, regression analysis to identify trends in emission reductions across time intervals. Method 400 further includes a step 420 of calculating, by the computer, ecological scores based on weighted inputs selected from a dropdown menu.

Thus, the present invention provides a system (also referred to as an environmental monitoring system) to calculate and verify individual greenhouse gas (GHG) emissions based on personal consumption patterns. The eco-verification system integrates data from a variety of sources, including service providers, data aggregators, and manual user inputs, to compile a comprehensive dataset of consumption activities. Key components of the system include multiple data acquisition mechanisms, such as direct data collection from utility providers, standardized handling of aggregated data, and manual input functionality. Collected data is processed through adapters that normalize and standardize the inputs, after which it is categorized to enable accurate emissions estimation by a Greenhouse Gas Emissions Calculator. The resulting outputs include an EcoIndex, which quantifies the user's annual GHG emissions. In cases where the EcoIndex falls below a predefined emissions threshold, the system may generate a QR code containing a digitally signed SSL certificate to verify the user's environmental compliance. The user interface of the present system is accessible via multiple platforms, including mobile applications and web portals to facilitate user interaction and system accessibility.

Further, the present invention automates the collection of consumption data through secure APIs, removing the need for manual data input by users. Unlike existing solutions that primarily focus on employees within companies, this system provides real-time emissions data at the individual level, making it applicable to all persons, regardless of their organizational affiliation. The system introduces a novel method of decarbonization by calculating the difference between successive ecoverification results, providing a precise measure of emissions reduction over time. This method allows for an accurate, time-based assessment of an individual's decarbonization efforts. Further, the present system provides an Ecoverification Badge, which serves as both a visual representation of an individual's emissions status and a tool to promote environmental awareness, responsibility, and accountability. By offering this badge, the system encourages users to engage in sustainable consumption practices and provides tangible feedback on their progress in reducing their carbon footprint.

Additionally, the present system has several potential applications such as environmental monitoring and reporting by businesses with large customer bases to offer sustainability insights to their consumers. Governments, particularly ministries focused on social and ecological issues, could also leverage the system for tracking and promoting individual sustainability efforts. Additionally, the system could be integrated into corporate ESG reporting frameworks, enhancing transparency and accountability with respect to customer or employee emissions. Finally, the system could serve consumer-facing applications that empower individuals to monitor and reduce their carbon footprint, fostering broader engagement in sustainable practices.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for tracking and verifying greenhouse gas (GHG) emissions and decarbonization, comprising:
a memory storing program instructions;
a processor coupled to the memory and configured to execute the program instructions;
wherein execution of the program instructions causes the processor to:
collect consumption data from at least one source selected from the group consisting of service provider application programming interfaces (APIs), data aggregators, manual user input, and user-permitted access to third-party data;
compute a decarbonization value for at least one user based on a temporal comparison between at least two eco-verification datasets;
generate one or more machine-readable codes embedding verified GHG emission data and/or digitally signed environmental certifications;
obtain activity or mobility data from one or more wearable devices via one or more APIs;
enable rating of ecological practices of commercial properties via a map-based interface according to predefined criteria;
authenticate users and reviewers via an access control mechanism;
aggregate collected data and compute GHG emissions using predefined conversion metrics, wherein the GHG emissions are determined from at least one smart device or household sensor feed; and
display, via a digital interface, at least one of verified consumption data, eco-badges, GHG trends, and historical decarbonization timelines.

2. The system of claim 1, wherein the processor is further configured to execute instructions that cause the system to implement a permission layer providing user-specific control over at least one each external data source.

3. The system of claim 1, wherein the processor is further configured to execute instructions that cause a GHG meter to provide a real-time dashboard that displays emissions levels and trigger alerts upon the emission levels exceeding one or more predefined consumption thresholds.

4. The system of claim 1, wherein the processor is further configured to execute instructions that cause the system to apply one or more statistical modeling techniques, including but not limited to regression analysis to identify trends in emission reductions across one or more time intervals.

5. The system of claim 1, wherein the processor is further configured to execute instructions that cause the system to calculate ecological scores based on weighted inputs selected from a dropdown menu.

6. The system of claim 1, wherein the processor is configured to execute instructions that cause the digital interface to issue one or more eco-badges comprising “EcoVerified” and “EcoVerified After Compensation” or any functional equivalent thereof based on cumulative emissions data.

7. The system of claim 1, wherein the processor is further configured to execute instructions that cause the system to define at least four user roles comprising an individual user, a reviewer, a third-party verifier, and a public viewer, or any functional equivalents.

8. The system of claim 1, wherein the processor is further configured to execute instructions that cause the digital interface to assign the one or more eco-badges based on one or more GHG emission thresholds.

9. The system of claim 1, wherein the processor is further configured to execute instructions that cause the system to incorporate review-based inputs, including but not limited to inputs from the eco-rating module into a decarbonization estimation formula.

10. The system of claim 1, wherein the set of sources comprising one or more data sources, including but not limited to a set of service provider APIs, a set of data aggregators, a manual user input, and a user-permitted access to third-party data.

11. A method for tracking and verifying greenhouse gas (GHG) emissions and decarbonization, comprising:
collecting, by a computer, consumption data from a set of sources;
computing, by the computer, a decarbonization value of one or more users based on a temporal comparison between at least two eco-verification datasets;
generating, by the computer, a set of machine-readable codes to embed one or more of verified GHG emission data and a set of digitally signed environmental certifications;
collecting, by the computer, one or more of real-time activity data, and mobility data from a set of wearable devices via a set of Application Programming Interfaces (APIs);
allowing, by the computer, the one or more users to rate ecological practices and services of one or more commercial properties based on predefined criteria; and
supporting, by the computer, secure identification of the one or more users and a set of reviewers;
aggregating, by a GHG meter, collected data and computing GHG emissions using a set of predefined conversion metrics, wherein the GHG meter is integrated with a set of household sensor feeds and capable of receiving data from a set of smart devices; and
displaying, by a digital interface, one or more of verified consumption data, one or more eco-badges, a set of GHG trends, and a set of historical decarbonization timelines.

12. The method of claim 11, wherein executing the instructions further causes the system to provide a GHG meter with a real-time dashboard configured to display emissions levels and trigger alerts upon exceeding one or more predefined consumption thresholds.

13. The method of claim 11, further comprising executing the instructions to apply one or more statistical modeling techniques, including but not limited to regression analysis to identify trends in emission reductions across one or more time intervals.

14. The method of claim 11, further comprising executing the instructions to calculate ecological scores based on weighted inputs selected from a dropdown menu.

15. The method of claim 11, wherein executing the instructions causes the digital interface to assign one or more eco-badges comprising “EcoVerified” and “EcoVerified After Compensation”, or any functional equivalent thereof based on cumulative emissions data.

16. The method of claim 11, wherein executing the instructions causes the digital interface to assign the one or more eco-badges based on GHG emission thresholds.

17. The method of claim 11, wherein the set of sources comprises one or more data sources, including but not limited to sets of service provider APIs, a set of data aggregators, a manual user input, and a user-permitted access to third-party data.

18. A system for tracking and verifying greenhouse gas (GHG) emissions and decarbonization, comprising:
a data acquisition module configured to collect consumption data from a set of sources;
a decarbonization quantification module configured to compute a decarbonization value of one or more users based on a temporal comparison between at least two eco-verification datasets;
a digital certification module configured to generate a set of machine-readable codes to embed one or more of: verified GHG emission data and a set of digitally signed environmental certifications;
a wearable integration module configured to collect one or more of real-time activity data, and mobility data from a set of wearable devices via a set of health APIs;
an eco-rating module comprising a map-based interface configured to allow the one or more users to rate ecological practices of commercial properties based on predefined criteria; and
an access control and authentication module configured to support secure identification of the one or more users and a set of reviewers; and
a GHG meter configured to aggregate collected data and compute GHG emissions using a set of predefined conversion metrics, wherein the GHG meter is integrated with a set of household sensor feeds and capable of receiving data from a set of smart devices; and
a digital interface configured to display one or more of verified consumption data, one or more eco-badges, a set of GHG trends, and a set of historical decarbonization timelines.

19. The system of claim 18, wherein data acquisition module comprises a permission layer to enable a user-specific control over at least one each external data source.

20. The system of claim 18, wherein the GHG meter comprises a display for emissions levels and trigger alerts upon the emission levels exceeding one or more predefined consumption thresholds.
